(19) United States
(12) Patent Application Publication
(10) Pub. No.: US 2025/0355743 A1
(43) Pub. Date: Nov. 20, 2025

(54) VALLEY TRACK READS TO REDUCE MEMORY SYSTEM SCAN OVERHEAD

(71) Applicant: Micron Technology, Inc., Boise, ID (US)

(72) Inventors: Daniel Danching Zhang, Milpitas, CA (US); Prashant Parashari, Hyderabad (IN); John William Slattery, Boulder, CO (US); Dongxiang Liao, Cupertino, CA (US)

(21) Appl. No.: 19/195,422

(22) Filed: Apr. 30, 2025

Related U.S. Application Data
(60) Provisional application No. 63/648,062, filed on May 15, 2024.

(51) Int. Cl. G06F 11/07

(52) U.S. Cl. CPC G06F 11/076; G06F 11/073

(57) ABSTRACT

Methods, systems, and devices for valley track reads to reduce memory system scan overhead are described. A memory system may use a valley track procedure to perform an initial scan of one or more memory cells and determine whether to refresh the one or more memory cells. In some cases, the valley track procedure may include at least two calibrations, where a coarse calibration associated with a default read voltage may indicate an entry of mapping information, and a fine calibration may use the entry to determine a read voltage. The fine calibration may include application of the read voltage to the one or more memory cells to determine a bit error count (BEC). The memory system may determine whether to refresh the one or more memory cells based on the BEC and a threshold BEC.

### CROSS REFERENCE

The present application for patent claims priority to U.S. Patent Application No. 63/648,062 by Zhang et al., entitled “VALLEY TRACK READS TO REDUCE MEMORY SYSTEM SCAN OVERHEAD,” filed May 15, 2024, which is assigned to the assignee hereof, and which is expressly incorporated by reference in its entirety herein.

### TECHNICAL FIELD

The following relates to one or more systems for memory, including valley track reads to reduce memory system scan overhead.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports valley track reads to reduce memory system scan overhead in accordance with examples as disclosed herein.

FIG. 2 shows an example of a flow diagram that supports valley track reads to reduce memory system scan overhead in accordance with examples as disclosed herein.

FIG. 3 shows a block diagram of a memory system that supports valley track reads to reduce memory system scan overhead in accordance with examples as disclosed herein.

FIG. 4 shows a flowchart illustrating a method or methods that support valley track reads to reduce memory system scan overhead in accordance with examples as disclosed herein.

### DETAILED DESCRIPTION

In some memory systems, periodic background scans may be performed on one or more memory cells of the memory system (e.g., a not-AND (NAND) system, or some other type of system) to detect (e.g., and possibly correct) data errors. In some cases, the periodic background scans may include multiple stages. For example, a background scan may include an initial read of one or more memory cells, and the initial read may indicate whether to perform additional reads (e.g., a deeper check, a deeper valley health check, sequential scans) on the one or more memory cells as part of the background scan. The initial read may include reading data from the one or more memory cells and determining an initial bit error count (BEC) associated with the one or more memory cells. The initial BEC may be compared with an initial BEC threshold. If the initial BEC satisfies the initial BEC threshold, the periodic background scan may also include the one or more additional reads of the one or more memory cells. The one or more additional reads may generate a second BEC, which may be compared with a second threshold (e.g., a deep threshold) to determine whether to refresh the one or more memory cells. In some cases, performing the one or more additional reads may involve performing a quantity of (e.g., three or more) reads on the one or more memory cells and a relatively complex process (e.g., algorithm or other calculation or processing technique) to calculate a voltage threshold distribution for the one or more memory cells and generate (e.g., determine, estimate) the second BEC. If the second BEC satisfies the second threshold, the memory system may refresh the one or more memory cells. Refreshing the one or more memory cells may include, in some examples, rewriting, by the memory system, the data stored in the one or more memory cells to one or more different memory cells. In some cases, performing the one or more additional reads as part of the periodic background scans may further degrade the memory cells and increase processing, latency, and complexity in the memory system. Additionally, or alternatively, if a BEC associated with the one or more memory cells is between the initial threshold and the second threshold, the one or more additional reads may be performed in each scan of the one or more memory cells, but may result in no action (e.g., the additional reads may be unnecessary). Thus, a method of determining whether to refresh memory cells with reduced latency and degradation of the memory cells may be beneficial.

According to techniques described herein, a memory system (e.g., a memory device, a controller) may use a valley track procedure to perform an initial scan of one or more memory cells and determine whether to refresh the one or more memory cells. The use of a valley track read to determine whether to refresh memory cells as described herein may reduce a total quantity of reads that are performed as part of a scanning operation. For example, the memory system may refrain from performing the additional reads associated with the periodic background scans. In some cases, the valley track procedure may include at least two calibrations. A first (e.g., coarse) calibration (e.g., an initial scan) may include the memory system applying a default read voltage to read one or more memory cells and determine (e.g., estimate, calculate) a second BEC associated with the one or more memory cells based on the default read voltage. The second BEC may indicate (e.g., map to or otherwise be associated with) an entry of mapping information (e.g., within a look-up table) stored by the memory system. The memory system may use the mapping information in the identified entry to determine a read voltage to apply to the one or more memory cells as part of a second (e.g., fine) calibration (e.g., a second scan). The memory system may apply the read voltage to the one or more memory cells and determine a first BEC of the one or more memory cells based on the read voltage. That is, the fine calibration may perform a read operation (e.g., a single read operation) of the one or more memory cells based on the read voltage to determine the first BEC, which may reduce a latency and total quantity of program and erase cycles for the one or more memory cells as compared with the one or more additional reads that may be applied in other background scan operations. The memory system may determine whether to refresh the one or more memory cells based on the first BEC and a threshold BEC.

In addition to applicability in memory systems described herein, techniques for valley track reads that reduce memory system scan overhead may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by improving memory storage and retention or accuracy of data over time, which may improve security of data storage, among other benefits.

Additionally, or alternatively, techniques for valley track reads that reduce memory system scan overhead may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing error rates associated with memory cells, reducing latency for background scanning in a memory system, and increasing a reliability and capacity of memory storage, which may decrease latency times (e.g., latency associated with performing background scans and error handling), improve memory reliability, or otherwise improve user experience, among other benefits.

Additionally, or alternatively, techniques for valley track reads that reduce memory system scan overhead may be generally implemented to support cloud computing and storage applications. As the use of cloud computing to provide processing, storage, and networking services to multiple devices increases, many devices and systems may benefit from improved remote processing and storage capabilities. For example, increasing memory capacity or other capabilities may result in larger and more accessible storage options for users, and increasing memory access times may result in faster processing for computing or database applications. Implementing the techniques described herein may support cloud computing and storages techniques by supporting higher capacity memory devices (e.g., quad-level cell devices, tri-level cell devices) with increased longevity, which may improve storage (e.g., cloud storage), among other benefits.

Features of the disclosure are illustrated and described in the context of systems, devices, and circuits. Features of the disclosure are further illustrated and described in the context of flow diagrams and flowcharts.

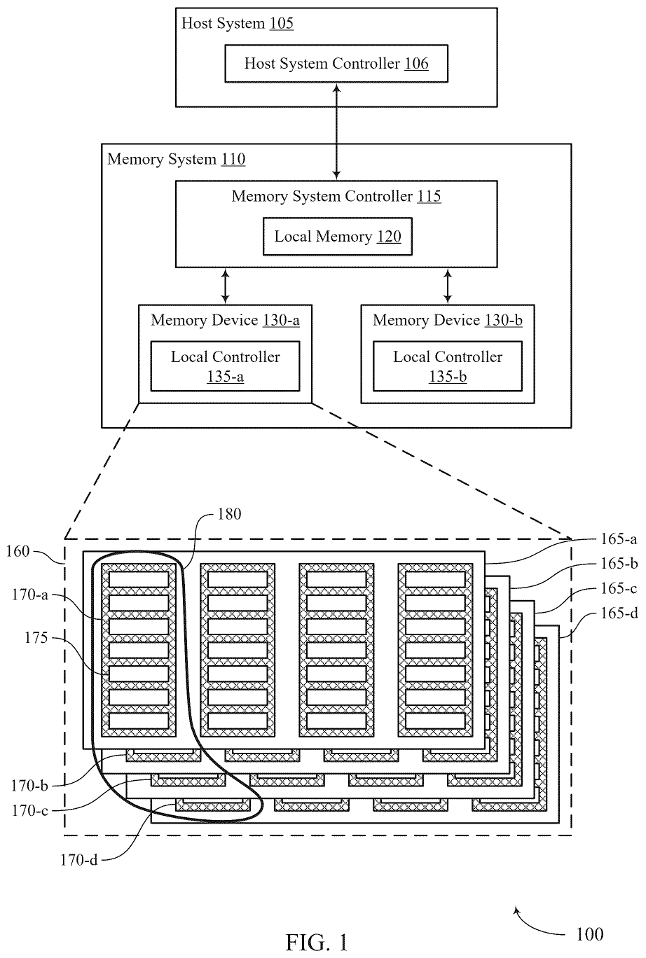

FIG. 1 shows an example of a system 100 that supports valley track reads to reduce memory system scan overhead in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some cases, a memory system 110 may perform periodic background scans on one or more memory cells of the memory system 110 to detect (e.g., and possibly correct) data errors. In some cases, the periodic background scans may include multiple stages. For example, a background scan may include an initial read of one or more memory cells, and the initial read may indicate whether to perform additional reads (e.g., a deeper check, a deeper valley health check, sequential scans) on the one or more memory cells as part of the background scan. The initial read may include reading data from the one or more memory cells and determining an initial BEC associated with the one or more memory cells. The initial BEC may be compared with an initial BEC threshold. If the initial BEC satisfies the initial BEC threshold, the periodic background scan may also include the one or more additional reads of the one or more memory cells. The one or more additional reads may generate a second BEC, which may be compared with a second threshold (e.g., a deep threshold) to determine whether to refresh the one or more memory cells. For example, if the second BEC associated with the additional reads satisfies the second threshold, the memory system 110 may refresh the one or more memory cells. In some cases, refreshing the memory cells may include transferring (e.g., by the memory system) the data from the one or more memory cells to one or more different memory cells, erasing the data from the one or more memory cells, writing different data to the one or more memory cells, or any combination thereof.

In some cases, performing the one or more additional reads may involve performing a quantity (e.g., three or more) reads on the one or more memory cells and a relatively complex algorithm to calculate a voltage threshold distribution for the one or more memory cells and the second BEC. In some cases, performing the one or more additional reads as part of the periodic background scans may further degrade the memory cells and increase processing, latency, and complexity in the memory system. Additionally, if a BEC associated with the one or more memory cells is between the initial threshold and the second threshold, the one or more additional reads may be performed in each scan of the one or more memory cells, but may result in no action (e.g., the additional reads may be unnecessary). Thus, a method of determining whether to refresh memory cells with reduced latency and degradation of the memory cells may be beneficial.

According to techniques described herein, the memory system 110 (e.g., or the memory devices 130, a memory system controller 115, a local controller 135) may use a valley track procedure to perform an initial scan of one or more memory cells and determine whether to refresh the one or more memory cells. The use of a valley track read to determine whether to refresh memory cells as described herein may reduce a total quantity of reads that are performed as part of a scanning operation. In some cases, the valley track procedure may include at least two calibrations. A first (e.g., coarse) calibration (e.g., an initial scan) ma include the memory system applying a default read voltage to read one or more memory cells and determine (e.g., estimate, calculate) a second BEC associated with the one or more memory cells based on the default read voltage. The second BEC may indicate (e.g., map to or otherwise be associated with) an entry of mapping information (e.g., within a look-up table) stored by the memory system. The memory system may use the mapping information in the identified entry to determine a read voltage to apply to the one or more memory cells as part of a second (e.g., fine) calibration (e.g., a second scan). The memory system may apply the read voltage to the one or more memory cells and determine a first BEC of the one or more memory cells based on the read voltage. That is, the fine calibration may perform a read operation (e.g., a single read operation) of the one or more memory cells based on the read voltage to determine the first BEC, which may reduce a latency and total quantity of program and erase cycles for the one or more memory cells as compared with the one or more additional reads that may be applied in other background scan operations. The memory system may determine whether to refresh the one or more memory cells based on the first BEC and a threshold BEC.

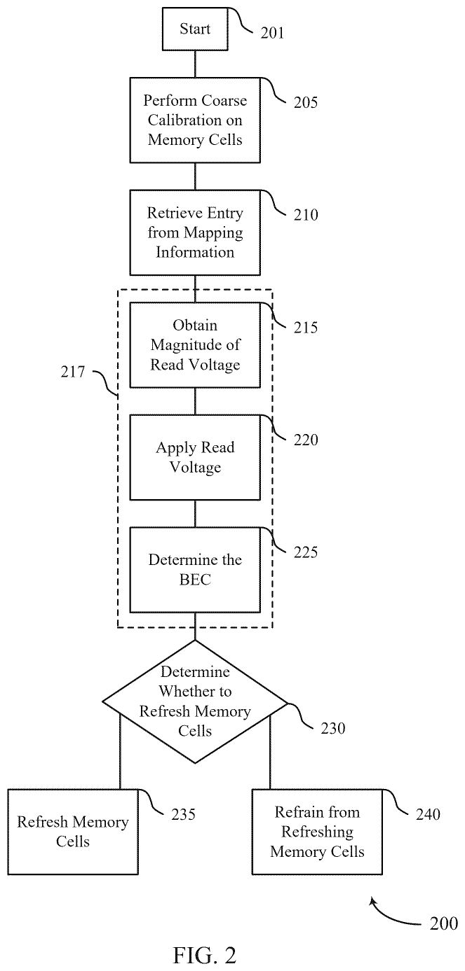

FIG. 2 shows an example of a flow diagram 200 that supports valley track reads to reduce memory system scan overhead in accordance with examples as disclosed herein. In some cases, aspects of the flow diagram 200 may implement or be implemented by aspects of FIG. 1. For example, a memory system, a memory device, or one or more controllers may implement the flow diagram 200, which may be examples of a memory system 110, the memory devices 130, the memory system controller 115, or the local controllers 135 as described herein with respect to FIG. 1. The flow diagram 200 may illustrate one or more operations for performing valley track reads to reduce memory system scan overhead. For example, the flow diagram 200 may illustrate a process for performing a read (e.g., a single read) to determine whether to refresh a memory cell by applying a read voltage selected based on mapping information (e.g., a look-up table).

A memory system (e.g., memory system 110) may store data in one or more memory cells which each store one or more bits of the data. A memory cell may store the one or more bits as a voltage level. For example, each logical value that can be described by the one or more bits may correspond to a respective threshold voltage level to be stored in a memory cell. In some cases, a plurality of memory cells in the memory system may attempt to store a same logical value but may be associated with (e.g., store) varying voltage levels. However, as long as the varying voltage levels remain within a threshold range around a threshold voltage level for the logical value, the memory system may read the correct logical value from the plurality of memory cells. For example, on a histogram corresponding to a plurality of memory cells storing a plurality of different logical values, with a horizontal axis corresponding to voltage level in a memory cell and a vertical axis corresponding to a quantity of memory cells storing each voltage level, each threshold voltage level may form a peak (e.g., the top of a hill) on the histogram, with a larger relative quantity of memory cells close to the threshold voltage levels. A mid-point between the threshold voltage levels in the histogram may form a trough (e.g., a valley), with a smaller relative quantity of memory cells storing voltage levels between the threshold voltage levels. Each hill around each threshold voltage level may be referred to as a voltage distribution for one or more memory cells for a threshold voltage level.

Over time, memory cells in the memory system may degrade (e.g., due to access operations, operating temperature, physical damage, or the like during a lifetime of the memory system). Such degradation of the memory cells may increase a variation in voltage levels stored in the memory cells to represent a same logical value (e.g., the hills of the histogram may become smaller and wider). In some cases, the increased variation in the voltages for different logical values may cause the troughs of the histogram to become less deep (e.g., more memory cells may store voltage levels in between the threshold voltage levels), such that the peaks of the histogram may come closer together or overlap over time due to wear on the memory cells. When such degraded memory cells are accessed, the distorted voltage levels may cause inaccurate accesses (e.g., reads, writes), or may result in a failure of an access operation, among other examples. Thus, the increased variation in the voltage levels may decrease a reliability of the memory cells and introduce errors when accessing the memory cells.

Some memory systems may perform periodic background scans (e.g., media management scans) of the system to check for degradation and errors associated with the memory cells of the memory system. The memory system, a memory device, one or more controllers, or any combination thereof (e.g., as described herein with respect to FIG. 1) may perform such background scans in an attempt to identify errors and refresh the memory cells (e.g., write the data of the memory cells to another memory location and erase the memory cells, reprogram the memory cells to a threshold voltage level) prior to the data becoming corrupted, which may lead to data loss and quality of service (QOS) degradation due to frequent error recovery. In some cases, the background scans may include a first initial read of the data stored in the memory cells. If a BEC associated with the initial read satisfies an initial threshold (e.g., is greater than or equal to the initial threshold), the memory system may trigger one or more additional reads (e.g., a deeper scan) of the data stored in the memory cells. The one or more additional reads may include a quantity of reads (e.g., three or more reads, among other quantities of reads) that may support accurate measurement of a second BEC (e.g., one or more second BECs) at different voltage levels of the data (e.g., measure the valley health of the memory cells), and may include a longer-latency calibration read of the memory cells. If the second BEC satisfies a second threshold (e.g., are greater than or equal to a deep threshold), the memory system may refresh the memory cells.

However, such periodic background scans may degrade the memory cells and cause latency in the memory system. For example, a set of memory cells may be associated with a BEC that is greater than or equal to the initial threshold but less than the deep threshold, which may cause the memory system to perform repeated additional reads on the set of memory cells without action (e.g., without refreshing the memory cells), for example, until the BEC reaches the deep threshold. Such repeated additional reads may cause latency for other operations of the memory system and may degrade the set of memory cells due to wear from being read relatively often.

Additionally, or alternatively, some memory systems may perform a valley track operation, which may use mapping information (e.g., a look-up table) to determine a read voltage (e.g., read thresholds). The valley track operation may include a coarse calibration (e.g., a first valley tracking coarse calibration) followed by one or more fine calibrations (e.g., second valley tracking fine calibrations). For example, a controller (e.g., memory system controller 115, local controller 135) may perform the coarse calibration on one or more memory cells. The coarse calibration may include applying a default voltage (e.g., a failed byte count voltage strobe, Dcfbyte strobe) for a set period of time to the one or more memory cells. For example, applying the default voltage may include applying a waveform to the memory cells, where the waveform ramps up from an initial voltage (e.g., a ground voltage associated with the memory system) to a pass voltage (Vpass). After settling at Vpass, the waveform may decrease to the default voltage, which may have a magnitude that is less than Vpass and greater than the initial voltage. In some cases, a length of the set period of time may be configurable and set according to implementation. The controller may read a raw code word (i.e., a series of a fixed quantity of bits) from the one or more memory cells based on the default voltage, and may apply the raw code word to an error correcting code (ECC) decoder to generate a decoded code word. A quantity of flipped bits between the decoded code word and the raw code word may represent an initial BEC of the one or more memory cells.

The controller may configure both a read voltage level and one or more additional parameters associated with the fine calibration based on the initial BEC. The one or more parameters associated with the fine calibration may include a bit line voltage to be applied to a bit line associated with the one or more memory cells, a pass voltage (e.g., Vpasslr) to be applied to one or more word lines adjacent to a word line associated with the one or more memory cells, a sensing duration, a temperature associated with operations at the memory system, or any combination thereof. Additionally, or alternatively, the controller (e.g., local controller 135, memory system controller 115) may maintain mapping information (e.g., a look-up table, other data structure) that stores a quantity of entries each associated with corresponding values of the initial BEC. Each entry may further include corresponding parameter values for the one or more parameters to be used when performing the fine calibration. The controller may determine an entry of the mapping information to use in determining a read voltage of the fine calibration operation. In this manner, the controller may configure the fine calibration more accurately than the coarse calibration via the mapping information.

The controller may perform the fine calibration operation (e.g., after the coarse calibration operation) on the one or more memory cells using the read voltage and the one or more parameters of the mapping information. The fine calibration may include, in some examples, a parallel auto-read calibration (pARC) operation on the one or more memory cells, which may include a sequence of one or more read operations at different read voltages, starting at and centered on the magnitude of the read voltage determined based on the default voltage and the entry of the mapping information. The controller may generate a histogram representing the BECs from the fine calibration and use the histogram to identify mid-points of valleys between adjacent threshold voltage levels (e.g., programming distributions), which may allow the controller to determine one or more operations to perform (e.g., including refresh operation).

According to the techniques described herein, a memory system 110 may determine whether to refresh one or more memory cells based on one or more BECs associated with the fine calibration of the valley track operation. In some cases, the one or more BECs associated with the fine calibration may be comparable in accuracy and utility to the one or more BECs that the memory system 110 may determine via the additional reads (e.g., deep check) of other types of periodic background scans, but may be generated (e.g., determined, estimated, calculated) with fewer read operations than in the other types of periodic background scans. In some cases, the memory system 110 may enable valley track as an initial scan (e.g., a singular initial scan and read operation) for a set of memory cells and may remove the additional reads (e.g., deep check) associated with other types of background scans, which may reduce a total quantity of reads on the set of memory cells and simplify one or more aspects of the memory system 110 (e.g., architecture design, firmware implementation, validation test cases, among other examples). That is, the memory system 110 may enable valley track on scan reads, may remove deep check from all reads, and may use BEC results to make decisions for subsequent accesses. The flow diagram 200 illustrates a process for a memory system to use the valley track operation in such a manner.

In the following description of flow diagram 200, the operations may be performed in a different order than the order shown, or other operations may be added or removed from the flow diagram 200. For example, some operations may also be left out of the flow diagram 200, may be performed in different orders or at different times, or other operations may be added to flow diagram 200. Although a memory system (e.g., the memory system 110) may perform the operations of flow diagram 200, some aspects of some operations may also be performed by one or more other memory systems, memory devices, host device, controller or other electronic devices (e.g., as described herein with respect to FIG. 1).

At 201, a memory system (e.g., the memory system 110) may start performing the operations of the flow diagram 200. For example, the memory system may receive a command to begin performing the operations of the flow diagram 200, or the memory system may determine to perform the operations of flow diagram 200 periodically. For example, the memory system may start performing the operation of flow diagram 200 at a periodicity associated with the background checks (e.g., as described herein).

At 205, the memory system may perform a coarse calibration (e.g., of a valley track operation, as described herein) on a set of memory cells (e.g., a set of one or more memory cells). In some cases, the coarse calibration may include applying a default read voltage to the set of memory cells to determine one or more parameters, as described herein. In some cases, each memory cell of the set of memory cells may be programmed to a voltage level of a set of voltage levels that represent data, and a magnitude of the default read voltage may be based on (e.g., may be equal to) the highest voltage level of the set of voltage levels. In some cases, the memory system may determine, based on the coarse calibration operation, an initial BEC (e.g., a second BEC) associated with the set of memory cells, where the one or more parameters may be based on the initial BEC (e.g., as described herein). In some cases, the one or more parameters may include a temperature associated with the memory system, a second BEC associated with the memory system, or both.

At 210, the memory system may retrieve, from mapping information (e.g., a look-up table) that may be stored by the memory system (e.g., in memory device(s) 130, in cache memory), an entry mapped to the one or more parameters associated with the set of memory cells of the memory system. In some cases, retrieving the entry may be based on the one or more parameters, a fine calibration operation, the coarse calibration operation, or any combination thereof.

At 217, the memory system may perform the fine calibration operation based on the mapping information. The operations at 215, 220, and 225 may be included in the fine calibration operation at 217. For example, the fine calibration may be described herein with respect to FIG. 2. The calibration operation at 217 may include one or more of the operations at 215, 220, and 225, and may include one or more other operations not shown in the flow diagram 200.

At 215, the memory system may obtain a magnitude of a read voltage for a later portion of the fine calibration operation based on the coarse calibration at 205 and the entry including the mapping information. For example, the memory system may obtain the read voltage by adjusting, as part of the fine calibration operation and based on the entry retrieved at 210, the magnitude of the default read voltage. That is, the read voltage may have a same magnitude as the adjusted magnitude of the default read voltage. The amount by which the default read voltage is adjusted may be based on the mapping information identified at 210. In some examples, the mapping information may include a voltage offset or some other voltage adjustment information.

At 220, the memory system may apply the read voltage to the set of memory cells as part of the fine calibration operation. In some cases, the memory system may apply the read voltage according to the one or more parameters described herein, as determined according to the coarse calibration at 205.

At 225, as part of the fine calibration operation, the memory system may determine a BEC associated with the set of memory cells based on applying the read voltage to the one or more memory cells. For example, the BEC may indicate a quantity of errors in data stored in the set of memory cells. In some cases, the BEC may be obtained relatively quickly via the operations of 205 through 225 as compared with other periodic background scan techniques that may include multiple read operations.

At 230, the memory system may determine whether to refresh the set of memory cells based on the BEC (e.g., the BEC associated with the fine calibration operation at 217) and a threshold BEC associated with the fine calibration operation. In some cases, the memory system may determine the threshold BEC based on one or more system settings (e.g., a threshold reliability setting, a temperature setting). For example, the memory system may compare the BEC associated with the fine calibration operation to the threshold BEC. The memory system may perform the operations of 235 if the second BEC is greater than or equal to the threshold BEC. The memory system may perform the operations of 240 if the second BEC is less than the threshold BEC.

At 235, the memory system may refresh the set of memory cells based on the BEC being greater than or equal to the threshold BEC. In some cases, refreshing the set of memory cells may include reading the data from the set of memory cells and writing the data to a second set of memory cells of the memory system, the second set of memory cells may be different from the set of memory cells. In some cases, the memory system may erase the data from the set of memory cells, program new data to the set of memory cells, or mark the set of memory cells as unusable (e.g., too degraded to be used), or any combination thereof.

At 240, the memory system may determine to refrain from refreshing the set of memory cells based on the BEC being less than the threshold BEC. That is, the memory system may continue storing the data in the set of memory cells for a duration based on the BEC being less than the threshold BEC. In some cases, the duration may be until a next start of the flow diagram 200 at 201. The duration may be based on a periodicity for scanning the memory system, based on the BEC, based on one or more other factors, or any combination thereof. For example, if the set of memory cells is associated with a higher BEC, the duration may be shorter, and if the memory cells are associated with a lower BEC, the duration may be longer, in some examples.

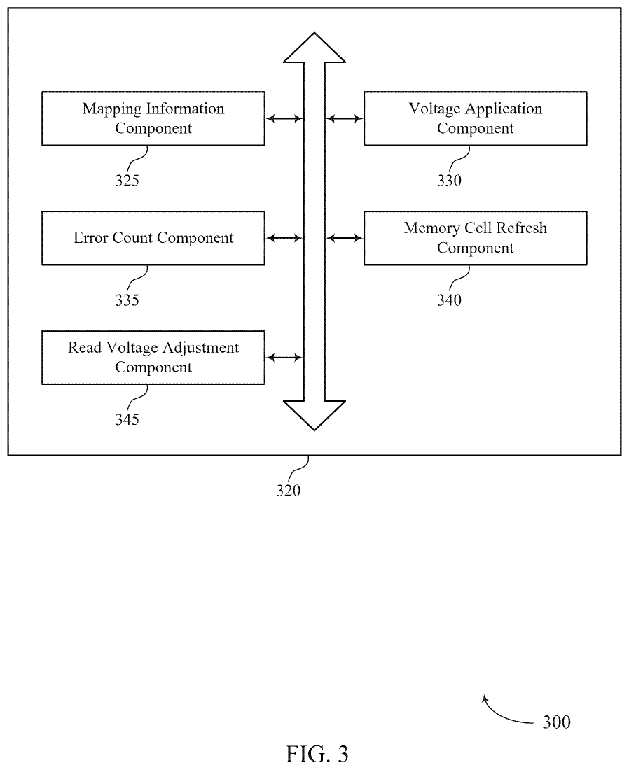

FIG. 3 shows a block diagram 300 of a memory system 320 that supports valley track reads to reduce memory system scan overhead in accordance with examples as disclosed herein. The memory system 320 may be an example of aspects of a memory system as described with reference to FIGS. 1 through 2. The memory system 320, or various components thereof, may be an example of means for performing various aspects of valley track reads to reduce memory system scan overhead as described herein. For example, the memory system 320 may include a mapping information component 325, a voltage application component 330, an error count component 335, a memory cell refresh component 340, a read voltage adjustment component 345, or any combination thereof. Each of these components, or components of subcomponents thereof (e.g., one or more processors, one or more memories), may communicate, directly or indirectly, with one another (e.g., via one or more buses).

The mapping information component 325 may be configured as or otherwise support a means for retrieving, from mapping information stored by the memory system, an entry mapped to one or more parameters associated with a set of memory cells of the memory system. The voltage application component 330 may be configured as or otherwise support a means for applying a read voltage to the set of memory cells, where a magnitude of the read voltage is based at least in part on the entry. The error count component 335 may be configured as or otherwise support a means for determining a bit error count associated with the set of memory cells based at least in part on applying the read voltage, the bit error count indicating a quantity of errors in data stored in the set of memory cells. The memory cell refresh component 340 may be configured as or otherwise support a means for determining whether to refresh the set of memory cells based at least in part on the bit error count and a threshold bit error count.

In some examples, to support determining whether to refresh the set of memory cells, the memory cell refresh component 340 may be configured as or otherwise support a means for comparing the bit error count to the threshold bit error count. In some examples, to support determining whether to refresh the set of memory cells, the memory cell refresh component 340 may be configured as or otherwise support a means for refreshing the set of memory cells based at least in part on the bit error count being greater than the threshold bit error count.

In some examples, to support refreshing the set of memory cells, the memory cell refresh component 340 may be configured as or otherwise support a means for reading the data from the set of memory cells. In some examples, to support refreshing the set of memory cells, the memory cell refresh component 340 may be configured as or otherwise support a means for writing the data to a second set of memory cells of the memory system that are different from the set of memory cells.

In some examples, to support determining whether to refresh the set of memory cells, the memory cell refresh component 340 may be configured as or otherwise support a means for comparing the bit error count to the threshold bit error count. In some examples, to support determining whether to refresh the set of memory cells, the memory cell refresh component 340 may be configured as or otherwise support a means for determining to refrain from refreshing the set of memory cells based at least in part on the bit error count being less than the threshold bit error count.

In some examples, the voltage application component 330 may be configured as or otherwise support a means for applying, as part of a coarse calibration operation to determine the one or more parameters, a default read voltage to the set of memory cells. In some examples, the error count component 335 may be configured as or otherwise support a means for determining, based at least in part on the coarse calibration operation, a second bit error count associated with the set of memory cells, where the one or more parameters are based at least in part on the second bit error count, and where retrieving the entry is based at least in part on the one or more parameters and a fine calibration operation.

In some examples, each memory cell of the set of memory cells is programmed to a voltage level of a set of voltage levels that represent the data. In some examples, a second magnitude of the default read voltage is based at least in part on the highest voltage level of the set of voltage levels.

In some examples, the read voltage adjustment component 345 may be configured as or otherwise support a means for adjusting, as part of a fine calibration operation and based at least in part on the entry, a second magnitude of a default read voltage to obtain the magnitude of the read voltage, where applying the read voltage to the set of memory cells is based at least in part on the fine calibration operation.

In some examples, the one or more parameters include a temperature associated with the memory system, a second bit error count associated with the memory system, or both.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

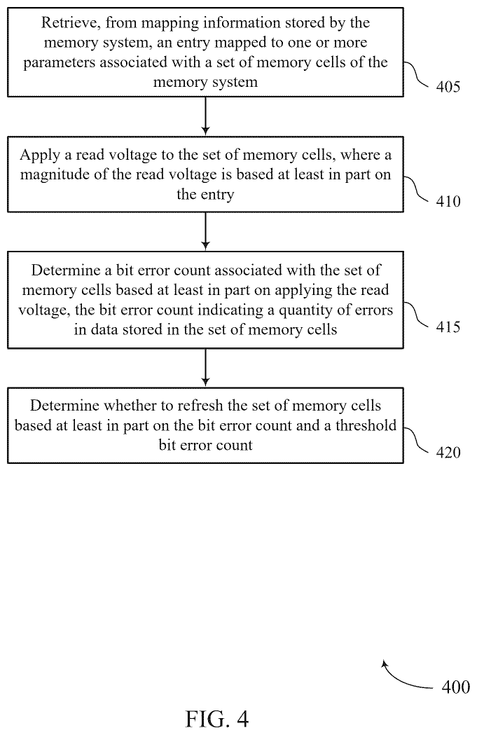

FIG. 4 shows a flowchart illustrating a method 400 that supports valley track reads to reduce memory system scan overhead in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include retrieving, from mapping information stored by the memory system, an entry mapped to one or more parameters associated with a set of memory cells of the memory system. In some examples, aspects of the operations of 405 may be performed by a mapping information component 325 as described with reference to FIG. 3.

At 410, the method may include applying a read voltage to the set of memory cells, where a magnitude of the read voltage is based at least in part on the entry. In some examples, aspects of the operations of 410 may be performed by a voltage application component 330 as described with reference to FIG. 3.

At 415, the method may include determining a bit error count associated with the set of memory cells based at least in part on applying the read voltage, the bit error count indicating a quantity of errors in data stored in the set of memory cells. In some examples, aspects of the operations of 415 may be performed by an error count component 335 as described with reference to FIG. 3.

At 420, the method may include determining whether to refresh the set of memory cells based at least in part on the bit error count and a threshold bit error count. In some examples, aspects of the operations of 420 may be performed by a memory cell refresh component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for retrieving, from mapping information stored by the memory system, an entry mapped to one or more parameters associated with a set of memory cells of the memory system; applying a read voltage to the set of memory cells, where a magnitude of the read voltage is based at least in part on the entry; determining a bit error count associated with the set of memory cells based at least in part on applying the read voltage, the bit error count indicating a quantity of errors in data stored in the set of memory cells; and determining whether to refresh the set of memory cells based at least in part on the bit error count and a threshold bit error count.

Aspect 2: The method, apparatus, or non-transitory computer-readable medium of aspect 1, where determining whether to refresh the set of memory cells includes operations, features, circuitry, logic, means, or instructions, or any combination thereof for comparing the bit error count to the threshold bit error count and refreshing the set of memory cells based at least in part on the bit error count being greater than the threshold bit error count.

Aspect 3: The method, apparatus, or non-transitory computer-readable medium of aspect 2, where refreshing the set of memory cells includes operations, features, circuitry, logic, means, or instructions, or any combination thereof for reading the data from the set of memory cells and writing the data to a second set of memory cells of the memory system that are different from the set of memory cells.

Aspect 4: The method, apparatus, or non-transitory computer-readable medium of aspect 1, where determining whether to refresh the set of memory cells includes operations, features, circuitry, logic, means, or instructions, or any combination thereof for comparing the bit error count to the threshold bit error count and determining to refrain from refreshing the set of memory cells based at least in part on the bit error count being less than the threshold bit error count.

Aspect 5: The method, apparatus, or non-transitory computer-readable medium of any of aspects 1 through 4, further including operations, features, circuitry, logic, means, or instructions, or any combination thereof for applying, as part of a coarse calibration operation to determine the one or more parameters, a default read voltage to the set of memory cells and determining, based at least in part on the coarse calibration operation, a second bit error count associated with the set of memory cells, where the one or more parameters are based at least in part on the second bit error count, and where retrieving the entry is based at least in part on the one or more parameters and a fine calibration operation.

Aspect 6: The method, apparatus, or non-transitory computer-readable medium of aspect 5, where each memory cell of the set of memory cells is programmed to a voltage level of a set of voltage levels that represent the data and a second magnitude of the default read voltage is based at least in part on a highest voltage level of the set of voltage levels.

Aspect 7: The method, apparatus, or non-transitory computer-readable medium of any of aspects 1 through 6, further including operations, features, circuitry, logic, means, or instructions, or any combination thereof for adjusting, as part of a fine calibration operation and based at least in part on the entry, a second magnitude of a default read voltage to obtain the magnitude of the read voltage, where applying the read voltage to the set of memory cells is based at least in part on the fine calibration operation.

Aspect 8: The method, apparatus, or non-transitory computer-readable medium of any of aspects 1 through 7, where the one or more parameters include a temperature associated with the memory system, a second bit error count associated with the memory system, or both.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memories storing processor-executable code; and
one or more processors coupled with the one or more memories and individually or collectively operable to execute the code to cause the memory system to:
retrieve, from mapping information stored by the memory system, an entry mapped to one or more parameters associated with a set of memory cells of the memory system;
apply a read voltage to the set of memory cells, wherein a magnitude of the read voltage is based at least in part on the entry;
determine a bit error count associated with the set of memory cells based at least in part on applying the read voltage, the bit error count indicating a quantity of errors in data stored in the set of memory cells; and
determine whether to refresh the set of memory cells based at least in part on the bit error count and a threshold bit error count.

2. The memory system of claim 1, wherein, to determine whether to refresh the set of memory cells, the one or more processors are individually or collectively operable to execute the code to cause the memory system to:
compare the bit error count to the threshold bit error count; and
refresh the set of memory cells based at least in part on the bit error count being greater than the threshold bit error count.

3. The memory system of claim 2, wherein, to refresh the set of memory cells, the one or more processors are individually or collectively operable to execute the code to cause the memory system to:
read the data from the set of memory cells; and
write the data to a second set of memory cells of the memory system that are different from the set of memory cells.

4. The memory system of claim 1, wherein, to determine whether to refresh the set of memory cells, the one or more processors are individually or collectively operable to execute the code to cause the memory system to:
compare the bit error count to the threshold bit error count; and
determine to refrain from refreshing the set of memory cells based at least in part on the bit error count being less than the threshold bit error count.

5. The memory system of claim 1, wherein the one or more processors are individually or collectively further operable to execute the code to cause the memory system to:
apply, as part of a coarse calibration operation to determine the one or more parameters, a default read voltage to the set of memory cells; and
determine, based at least in part on the coarse calibration operation, a second bit error count associated with the set of memory cells, wherein the one or more parameters are based at least in part on the second bit error count, and wherein retrieving the entry is based at least in part on the one or more parameters and a fine calibration operation.

6. The memory system of claim 5, wherein:
each memory cell of the set of memory cells is programmed to a voltage level of a set of voltage levels that represent the data, and
a second magnitude of the default read voltage is based at least in part on a highest voltage level of the set of voltage levels.

7. The memory system of claim 1, wherein the one or more processors are individually or collectively further operable to execute the code to cause the memory system to:
adjust, as part of a fine calibration operation and based at least in part on the entry, a second magnitude of a default read voltage to obtain the magnitude of the read voltage, wherein applying the read voltage to the set of memory cells is based at least in part on the fine calibration operation.

8. The memory system of claim 1, wherein the one or more parameters comprise a temperature associated with the memory system, a second bit error count associated with the memory system, or both.

9. A method at a memory system, comprising:
retrieving, from mapping information stored by the memory system, an entry mapped to one or more parameters associated with a set of memory cells of the memory system;
applying a read voltage to the set of memory cells, wherein a magnitude of the read voltage is based at least in part on the entry;
determining a bit error count associated with the set of memory cells based at least in part on applying the read voltage, the bit error count indicating a quantity of errors in data stored in the set of memory cells; and
determining whether to refresh the set of memory cells based at least in part on the bit error count and a threshold bit error count.

10. The method of claim 9, wherein determining whether to refresh the set of memory cells comprises:
comparing the bit error count to the threshold bit error count; and
refreshing the set of memory cells based at least in part on the bit error count being greater than the threshold bit error count.

11. The method of claim 10, wherein refreshing the set of memory cells comprises:
reading the data from the set of memory cells; and
writing the data to a second set of memory cells of the memory system that are different from the set of memory cells.

12. The method of claim 9, wherein determining whether to refresh the set of memory cells comprises:
comparing the bit error count to the threshold bit error count; and
determining to refrain from refreshing the set of memory cells based at least in part on the bit error count being less than the threshold bit error count.

13. The method of claim 9, further comprising:
applying, as part of a coarse calibration operation to determine the one or more parameters, a default read voltage to the set of memory cells; and
determining, based at least in part on the coarse calibration operation, a second bit error count associated with the set of memory cells, wherein the one or more parameters are based at least in part on the second bit error count, and wherein retrieving the entry is based at least in part on the one or more parameters and a fine calibration operation.

14. The method of claim 13, wherein:
each memory cell of the set of memory cells is programmed to a voltage level of a set of voltage levels that represent the data, and
a second magnitude of the default read voltage is based at least in part on a highest voltage level of the set of voltage levels.

15. The method of claim 9, further comprising:
adjusting, as part of a fine calibration operation and based at least in part on the entry, a second magnitude of a default read voltage to obtain the magnitude of the read voltage, wherein applying the read voltage to the set of memory cells is based at least in part on the fine calibration operation.

16. The method of claim 9, wherein the one or more parameters comprise a temperature associated with the memory system, a second bit error count associated with the memory system, or both.

17. A non-transitory computer-readable medium storing code, the code comprising instructions executable by one or more processors to:
retrieve, from mapping information stored by a memory system, an entry mapped to one or more parameters associated with a set of memory cells of the memory system;
apply a read voltage to the set of memory cells, wherein a magnitude of the read voltage is based at least in part on the entry;
determine a bit error count associated with the set of memory cells based at least in part on applying the read voltage, the bit error count indicating a quantity of errors in data stored in the set of memory cells; and
determine whether to refresh the set of memory cells based at least in part on the bit error count and a threshold bit error count.

18. The non-transitory computer-readable medium of claim 17, wherein the instructions to determine whether to refresh the set of memory cells are executable by the one or more processors to:
compare the bit error count to the threshold bit error count; and
refresh the set of memory cells based at least in part on the bit error count being greater than the threshold bit error count.

19. The non-transitory computer-readable medium of claim 18, wherein the instructions to refresh the set of memory cells are executable by the one or more processors to:
read the data from the set of memory cells; and
write the data to a second set of memory cells of the memory system that are different from the set of memory cells.

20. The non-transitory computer-readable medium of claim 17, wherein the instructions to determine whether to refresh the set of memory cells are executable by the one or more processors to:
compare the bit error count to the threshold bit error count; and
determine to refrain from refreshing the set of memory cells based at least in part on the bit error count being less than the threshold bit error count.

21. The non-transitory computer-readable medium of claim 17, wherein the instructions are further executable by the one or more processors to:
apply, as part of a coarse calibration operation to determine the one or more parameters, a default read voltage to the set of memory cells; and
determine, based at least in part on the coarse calibration operation, a second bit error count associated with the set of memory cells, wherein the one or more parameters are based at least in part on the second bit error count, and wherein retrieving the entry is based at least in part on the one or more parameters and a fine calibration operation.

22. The non-transitory computer-readable medium of claim 21, wherein:
each memory cell of the set of memory cells is programmed to a voltage level of a set of voltage levels that represent the data, and
a second magnitude of the default read voltage is based at least in part on a highest voltage level of the set of voltage levels.

23. The non-transitory computer-readable medium of claim 17, wherein the instructions are further executable by the one or more processors to:
adjusting, as part of a fine calibration operation and based at least in part on the entry, a second magnitude of a default read voltage to obtain the magnitude of the read voltage, wherein applying the read voltage to the set of memory cells is based at least in part on the fine calibration operation.

24. The non-transitory computer-readable medium of claim 17, wherein the one or more parameters comprise a temperature associated with the memory system, a second bit error count associated with the memory system, or both.
